(19) United States
(12) Patent Application Publication
(10) Pub. No.: US 2015/0230017 A1
(43) Pub. Date: Aug. 13, 2015

(54) EARPHONE RECEIVING CASE

(71) Applicants: Fu Tai Hua Industry (Shenzhen) Co., Ltd., Shenzhen (CN); HON HAI PRECISION INDUSTRY CO., LTD., New Taipei (TW)

(72) Inventor: QIAN LEI, Shenzhen (CN)

(21) Appl. No.: 14/498,592

(22) Filed: Sep. 26, 2014

(30) Foreign Application Priority Data
Feb. 13, 2014 (CN) 2014100499518

(51) Int. Cl. H04R 1/10

(52) U.S. Cl. CPC H04R 1/1033

(57) ABSTRACT

An earphone receiving case includes a top shell, a bottom shell, a coil spring, an earphone, and a button. The bottom shell engages with the top shell to define a receiving space. The coil spring is received in the receiving space. The earphone includes a headphone cable. Two ends of the headphone cable are always accessible outside the earphone receiving case. The button is movably fixed to the bottom shell and presses on a part of the headphone cable. A distal end of the coil spring is fixed to the headphone cable. The coil spring rotates to accumulate rotation energy when the headphone cable is pulled out from the earphone receiving case. When the first button is pressed, the part of the headphone cable being pressed is loosened, and the coil spring rotates to release the stored energy to retract the headphone cable back into the earphone receiving case.

### CROSS-REFERENCE TO RELATED APPLICATIONS

This application claims priority to Chinese Patent Application No. 201410049951.8 filed on Feb. 13, 2014, in the China Intellectual Property Office, the contents of which are incorporated by reference herein.

### FIELD

The present disclosure relates to cases for protecting electronic devices.

### BACKGROUND

Earphones can be inserted into portable electronic devices, such as mobile phones and MP3 playing devices, for listening to music. The headphone cable of the earphone can be long or short.

### BRIEF DESCRIPTION OF THE DRAWING

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of an embodiment of an earphone receiving case.

FIG. 2 is similar to FIG. 1, but viewed from another angle.

FIG. 3 is a partially exploded, isometric view of the earphone receiving case in FIG. 1.

FIG. 4 is an exploded, isometric view of the earphone receiving case in FIG. 1.

FIG. 5 is similar to FIG. 4, but viewed from another angle.

### DETAILED DESCRIPTION

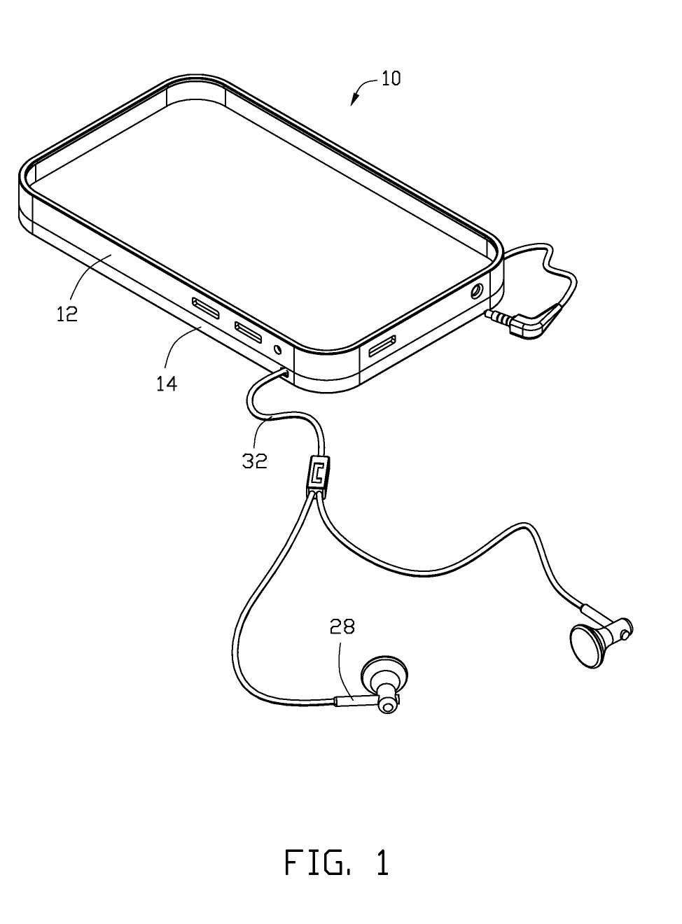

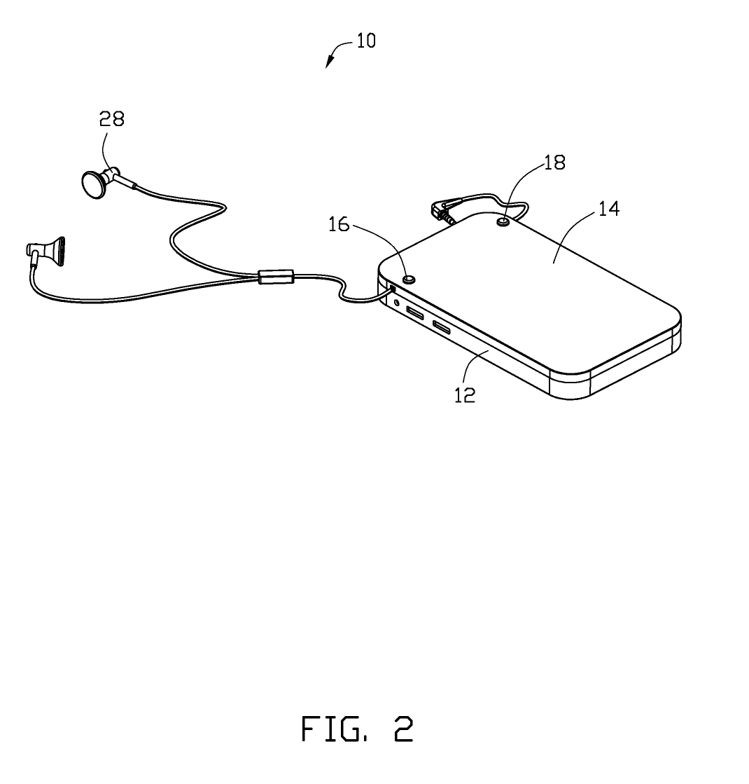

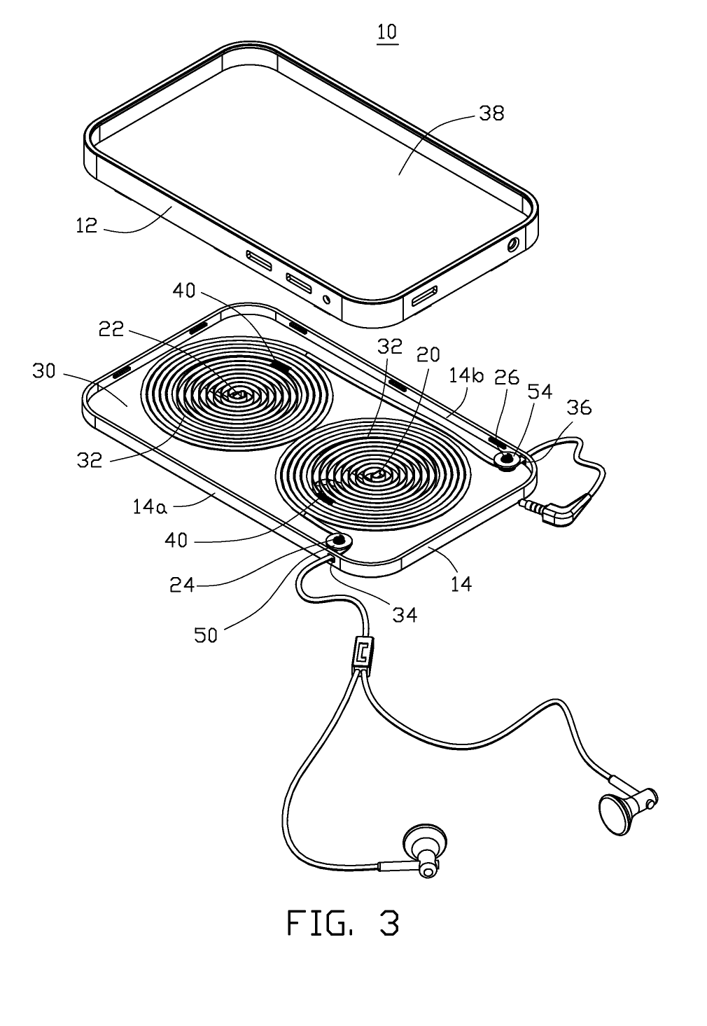

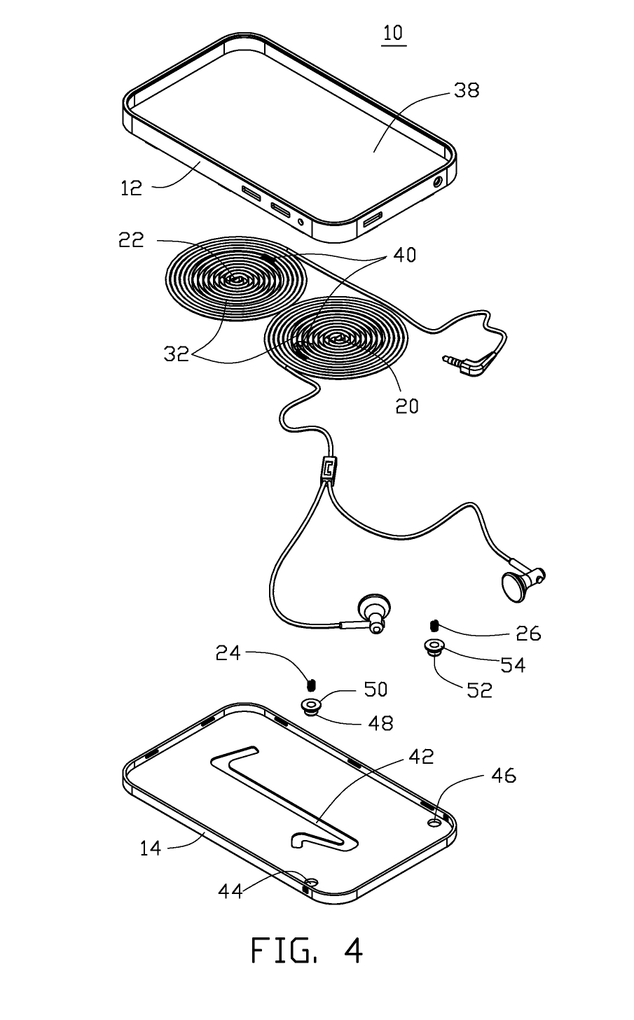

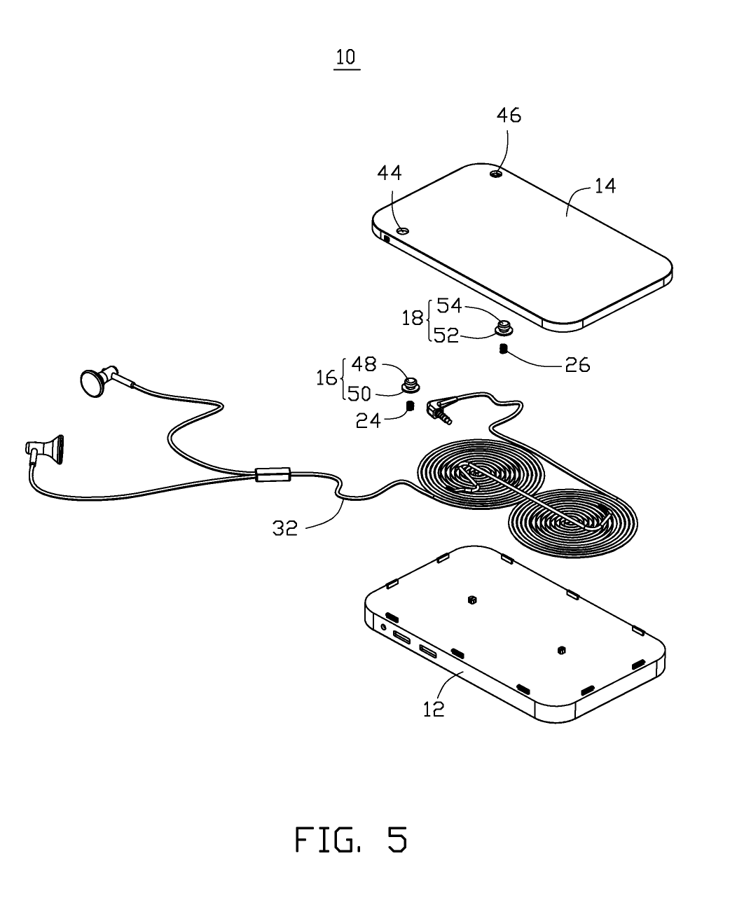

FIGS. 1-5 illustrate an earphone receiving case 10. The earphone receiving case 10 includes a top shell 12, a bottom shell 14, a first button 16, a second button 18, a first coil spring 20, a second coil spring 22, a first elastic piece 24, a second elastic piece 26, and an earphone 28.

The top shell 12 engages the bottom shell 14, and the top shell 12 and the bottom shell 14 cooperatively define a receiving space 30. The first coil spring 20 and the second coil spring 22 are side by side arranged in the receiving space 30. The earphone 28 includes a headphone cable 32. Two ends of the headphone cable 32 are both outside of the earphone receiving case 10. A part of the headphone cable 32 encircles the first coil spring 20 and the second coil spring 22. A distal end of the first coil spring 20 and a distal end of the second coil spring 22 are fixed to the headphone cable 32. When the headphone cable 32 is pulled out, the first coil spring 20 and the second coil spring 22 rotate and are placed under progressively greater compression. When the first coil spring 20 and the second coil spring 22 rotate to release stored energy, the headphone cable 32 is pulled back inside the receiving space 30.

In at least one embodiment, the bottom shell 14 includes a first sidewall 14a and a second sidewall 14b opposite a first sidewall 12a. The first sidewall 14a defines a first through hole 34. The second sidewall 14b defines a second through hole 36. An end of the headphone cable 32 passes through the first through hole 34. The other end of the headphone cable 32 passes through the second through hole 36 to be arranged out of the earphone receiving case 10. The top shell 12 defines an accepting space 38 at a side of the top shell 12 away from the bottom shell 14. The accepting space 38 is configured to receive an electronic device (not shown). The first coil spring 20 and the second coil spring 22 are tied to the headphone cable 32 by two splices 40. In another embodiment, the first coil spring 20 and the second coil spring 22 are adhered to the headphone cable 32 by a glue. The bottom shell 14 further defines a guiding groove 42. The headphone cable 32, from the splicing point of the first coil spring 20 to the splicing point of the second coil spring 22, is received in the guiding groove 42.

The bottom shell 14 defines a first receiving hole 44 and a second receiving hole 46. The first button 16 and the second button 18 are respectively received in the first receiving hole 44 and the second receiving hole 46. Both buttons 16 and 18 are movable within the receiving holes 44 and 46. The first button 16 includes a first pressing portion 48 and a first protrusion portion 50 protruding from the external surface of the first pressing portion 48. The pressing portion 48 is received in the first receiving hole 44, and the first protrusion portion 50 is received in the receiving space 30, preventing the first pressing portion 48 from breaking away from the first receiving hole 44. The second button 18 includes a second pressing portion 52 and a second protrusion portion 54. The second button 18 has a structure similar to the first button 16. Therefore, the structural detail of the second button 18 is omitted.

A first end of the first elastic piece 24 abuts against the top shell 12, and a second end of the first elastic piece 24 abuts against the first button 16. A part of the headphone cable 32 encircles the first pressing portion 48 and is pressed between the first protrusion portion 50 and the bottom shell 14, and is pressed under an elastic force of the first elastic piece 24. The pressing of protrusion portion 50 by physical contact frictionally resists retraction of the headphone cable 32. When the first pressing portion 48 is pressed, the first protrusion portion 50 overcomes the elastic force of the first elastic piece 24 and moves away from the bottom shell 14. Therefore, the headphone cable 32, which encircles the first pressing portion 48, is loosened, and the first coil spring 20 can rotate to release the stored energy. The headphone cable 32 adjacent to the first coil spring 20 can be pulled back into the receiving space 30.

A first end of the first elastic piece 26 abuts against the top shell 12, and a second end of the second elastic piece 26 abuts against the second button 18. A part of the headphone cable 32 encircles the second pressing portion 52 and is pressed between the second protrusion portion 54 and the bottom shell 14, and is under pressure from an elastic force of the second elastic piece 26. When the second pressing portion 52 is pressed, the second protrusion portion 54 overcomes the elastic force of the second elastic piece 26 and moves away from the bottom shell 14. Therefore, the headphone cable 32 encircling the second pressing portion 52 is loosened, and the second coil spring 22 can rotate to release the stored energy. The headphone cable 32 adjacent to the second coil spring 22 can be pulled back inside the receiving space 30.

In another embodiment, the earphone receiving case 10 can include only a button, an elastic piece, and a coil spring. In other words, the earphone receiving case 10 does not include the second button 18, the second elastic piece 26, or the second coil spring 22.

A length of the headphone cable 32 pulled out of the earphone receiving case 10 depends on a requirement of a user, and the headphone cable 32 will be automatically retracted into the earphone receiving case 10 when the earphone 28 is not in use.

It is understood that the present disclosure may be embodied in other forms without departing from the scope thereof. Thus, the present examples and embodiments are to be considered in all respects as illustrative and not restrictive, and the disclosure is not to be limited to the details given herein.

What is claimed is:

1. An earphone receiving case comprising:
a top shell;
a bottom shell having a receiving hole, and the bottom shell engaged with the top shell to define a receiving space;
a first coil spring received in the receiving space;
an earphone comprising a headphone cable, two ends of the headphone cable positioned out of the earphone receiving case; and
a first button movably received in the receiving hole and, having a first configuration, communicatively pressing a part of the headphone cable to frictionally resist;
wherein a distal end of the first coil spring is fixed to the headphone cable, the first coil spring rotates to accumulate rotation energy when a portion of the headphone cable is pulled from within the earphone receiving case, and when the first button is pressed, the part of the pressed headphone cable is releases, and the first coil spring rotates to release the rotation energy to pull the one end of the headphone cable back to the earphone receiving case.

2. The earphone receiving case as claimed in claim 1, further comprising:
a second coil spring received in the receiving space;
a second button movably fixed to the bottom shell and pressing another part of the headphone cable;
wherein a distal end of the second coil spring is fixed to the headphone cable, the second coil spring rotates to accumulate rotation energy when the other end of the headphone cable is pulled away from the earphone receiving case, and when the second button is pressed, the another part of the headphone cable is loosen, and the second coil spring rotates to release the rotation energy to pull the another one end of the headphone cable back to the earphone receiving case.

3. The earphone receiving case as claimed in claim 1, further comprises a first elastic piece, a first end of the first elastic piece abuts against the top shell, and a second other end of the first elastic piece abuts against the first button.

4. The earphone receiving case as claimed in claim 3, wherein the first button comprises a first pressing portion and a first protrusion portion protruding from the first pressing portion, the first protrusion portion is received in the receiving space, the part of the headphone cable is pressed between the bottom shell and the protrusion portion, the second other end of the first elastic piece abuts against the first protrusion portion.

5. The earphone receiving case as claimed in claim 2, further comprises a second elastic piece, a first end of the second elastic piece abuts against the top shell, and a second other end of the second elastic piece abuts against the second button.

6. The earphone receiving case as claimed in claim 2, wherein the first coil spring and the second coil spring are side by side arranged in the receiving space.

7. The earphone receiving case as claimed in claim 6, wherein the bottom shell further defines a guiding groove, the headphone cable from fixed to the first coil spring to fixed to the second coil spring is received in the guiding groove.

8. The earphone receiving case as claimed in claim 1, wherein the distal end of the first coil spring is tied to the headphone cable through a splice.

9. The earphone receiving case as claimed in claim 1, wherein the top shell defines an accepting space at a side of the top shell away from the bottom shell, the accepting space is configured to receive an electronic device.

10. The earphone receiving case as claimed in claim 1, wherein the top shell comprises a first sidewall and a second sidewall opposite the first sidewall, the first sidewall defines a first through hole, the second sidewall defines a second through hole, the two ends of the headphone cable respectively pass through the first through hole and the second through hole to be arranged out of the earphone receiving case.

11. An earphone receiving case comprising:
a top shell;
a bottom shell engaged with the top shell to define a receiving space;
an earphone comprising a headphone cable, a part of the headphone cable received in the receiving space and two ends of the headphone cable positioned out of the earphone receiving case;
a first coil spring, a distal end of the first coil spring fixed to the headphone cable; and
a first button movably fixed to the bottom shell;
wherein a distal end of the coil spring is fixed to the headphone cable, the first coil spring rotates in a first direction when one end of the headphone cable is pulled away from the earphone receiving case, a part of headphone cable is pressed between the first button and the bottom shell, and when the first button is pressed, the part of the pressed headphone cable is loosen, and the first coil spring rotates in a second direction reverse to the first direction to pull the headphone cable back to the earphone receiving space.

12. The earphone receiving case as claimed in claim 11, further comprising:
a second coil spring, a distal end of the second coil spring fixed to the headphone cable;
a second button movably fixed to the bottom shell;
wherein a distal end of the second coil spring is fixed to the headphone cable, the second coil spring rotates in a third direction when the other end of the headphone cable is pulled away from the earphone receiving case, another part of headphone cable is pressed between the second button and the bottom shell, and when the second button is pressed, the other part of the pressed headphone cable is loosen, and the second coil spring rotates in a forth direction reverse to the third direction to pull the headphone cable back to the receiving space.

13. The earphone receiving case as claimed in claim 11, further comprises a first elastic piece, a first end of the first elastic piece abuts against the top shell, and a second other end of the first elastic piece abuts against the first button.

14. The earphone receiving case as claimed in claim 13, wherein the first button comprises a first pressing portion and a first protrusion portion protruding from the first pressing portion, the first protrusion portion is received in the receiving space, the part of the headphone cable is pressed between the bottom shell and the protrusion portion, the second other end of the first elastic piece abuts against the first protrusion portion.

15. The earphone receiving case as claimed in claim 12, further comprises a second elastic piece, a first end of the second elastic piece abuts against the top shell, and a second other end of the second elastic piece abuts against the second button.

16. The earphone receiving case as claimed in claim 12, wherein the first coil spring and the second coil spring are side by side arranged in the receiving space.

17. The earphone receiving case as claimed in claim 16, wherein the bottom shell further defines a guiding groove, the headphone cable from fixed to the first coil spring to fixed to the second coil spring is received in the guiding groove.

18. The earphone receiving case as claimed in claim 11, wherein the distal end of the first coil spring is tied to the headphone cable through a splice.

19. The earphone receiving case as claimed in claim 11, wherein the top shell defines an accepting space at a side of the top shell away from the bottom shell, the accepting space is configured to receive an electronic device.

20. The earphone receiving case as claimed in claim 11, wherein the top shell comprises a first sidewall and a second sidewall opposite the first sidewall, the first sidewall defines a first through hole, the second sidewall defines a second through hole, the two ends of the headphone cable respectively pass through the first through hole and the second through hole to be arranged out of the earphone receiving case.
